(19) United States
(12) Patent Application Publication
(10) Pub. No.: US 2014/0006271 A1
(43) Pub. Date: Jan. 2, 2014

(54) CROSS-NETWORK ELECTRONIC PAYMENT PROCESSING SYSTEM AND METHOD

(71) Applicants: James A. Cashin, San Luis Obispo, CA (US); Harold Mark Hallikainen, Santa Maria, CA (US)

(72) Inventors: James A. Cashin, San Luis Obispo, CA (US); Harold Mark Hallikainen, Santa Maria, CA (US)

(73) Assignee: GLOBALEX CORP., Santa Monica, CA (US)

(21) Appl. No.: 13/536,569

(22) Filed: Jun. 28, 2012

(51) Int. Cl. G06Q 20/14; G06Q 20/40

(52) U.S. Cl. 705/40

(57) ABSTRACT

The present invention is a cross-network system and method for electronic payment processing using a unique universal ID (called “PID”) through which a user can securely and conveniently send payments to or receive payments from anyone who has access to the internet. The system comprises a communication interface, a processor and a database. The processor of the present invention generates universal IDs representing unique payment relationships between a user and third parties with whom the user wishes to make or receive payments. This system by utilizing PIDS represents a more secure and more convenient method for making payments across and within disparate internet networks. Using the system and method of the present invention, a user can authorize a payment to another person or entity or generate an invoice regardless of the user's point or type of entry.

### FIELD OF THE INVENTION

This invention relates generally to electronic payment processing. Specifically, this invention relates to methods of making payments to others regardless of the network on which the user enters the system.

### BACKGROUND OF THE INVENTION

Electronic payment systems are more cost effective than paper billing. The cost of generating and sending paper bills is usually higher and more cumbersome than sending payment electronically. Presently there are many devices and methods that electronically process bills. By way of example and not limitation, there are systems for electronically paying bills wherein the payor uses a home or office computer to access a centralized payment location or payment processor associated with the payee. Once the payor accesses the centralized payment location or processor, the payor can access the payor's bill and pay it by entering the applicable information from the payor's checking account or credit card and then authorizing a payment therefrom.

There also are other systems in which multiple payees forward their bills to a centralized payment service that gathers all the individual bills for member payors who then have to sign into the centralized payment service and authorize payment through either a registered bank account or credit card. There also are other centralized payment services that gather bills for each member payor and then forwards a listing of all of a payor's bills to the member payor as either a single or multiple electronic transmissions. After receipt, the payor can authorize payment through the centralized payment service by authorizing a debit from the payor's registered checking account or registered credit card. Some of these systems utilize single-item tokenization whereby the service generates tokens representing only the financial account information utilized in each payment transaction for security purposes.

A drawback to the prior art systems is that either the payor or the payee or both must be members of the centralized payment service, or the payor or payee must be a member of a certain provider's network, or have an account at a particular bank, or with a particular credit card in order to make a payment. A further drawback of the prior art systems is that, while individual credit card information may be masked via an individual item token, the systems do not contain a method for creating a unique and secure identifier that contains all of the data elements relating to the payment relationship between the payor and the payee. The absence of this identifier (or token) prevents parties with pre-existing payment relationships from being able to find and/or transact with one another across multiple networks or devices on a recurring basis in a secure and convenient manner.

Thus, one of the objects of the present invention is to create a unique identifier for each user and each payment relationship so that any network may be used to transmit payments, even if the payee is not a member of that network.

It is a further object of the present invention that a payment may be made by a payor regardless of which network or input device is used by the payor.

It is yet another object of the present invention to provide a method for making a recurring payment without the payor having to re-enter or store information about either the payor or about the payment relationship in multiple networks or locations for each transaction.

It is a further object of the present invention to provide a unique identifier to locate, authenticate, and take payment actions with respect to a third party with whom a payor has an existing payment relationship.

It is a further object of the present invention to provide a mechanism for sending electronic invoices or electronic payables notifications by creating a universal ID that prompts payment system participation by a target (i.e. recipient/third party) of the notification.

### SUMMARY OF THE INVENTION

The present invention is a cross-network system and method for electronic payment processing using a universal ID (“PID” or token) that represents the payment relationship between two parties that includes but is not limited to various network profiles of each party to the transaction, third party credit information, the payment and credit history between the parties (the user and the target, i.e. the person/entity to whom a payment is going to be made or to whom an invoice or electronic payable notifications has been sent), sources that can be used and the networks from which the user can initiate the transaction, so that the user can send or receive a payment regardless of the point or type of entry.

The system of the present invention comprises a communication interface that can be a computer, telephone, cellphone, Ipad, Kindle, mobile wallet, or any other device that is capable of transferring and receiving information electronically. The communication interface may also be a unique network such as, but not limited to, Facebook, LinkedIn, Twitter, My Space, Gmail, Yahoo Mail, as well as closed loop buyer-seller networks such as Ariba, Salesforce.com, Alibaba, or any other private or public network so long as the network requires that each user possess a unique user ID and password to identify the user. In addition to the communication interface, the system of the present invention also comprises a processor that is electronically accessible by the system user through the interface. The system of the present invention also comprises one or more databases that may be accessed by the processor. The system databases reside either in one or more dedicated servers and/or in the system processor. In a preferred embodiment of the present invention there are at least four unique databases due to multiple networks, origins of payment and payment relationships (hereinafter referred to as a “PID”). The four databases comprise a user profile database in which profile information related to each system user is stored; a user network database in which network IDs are stored which identify the different networks and hardware devices belonging to each system user; a payment source database in which tokens representing the different types of electronic payment sources belonging to each system user is stored; and a PID database in which all of the PIDs/tokens for each system and the user's payment relationships are stored together with payment relationship details associated with each unique payment relationship. The PIDs/tokens are created by the processor and contain all relevant profile and network information from all of the databases pertaining to that particular user-target relationship so that any future payments between the user and target regardless of which one is paying the other, will be facilitated. Alternatively, in another embodiment of the present invention, the information related to each system user and/or the PID information may be stored locally on the system user's access devices.

The processor of the present invention is connected both to the communication interface and databases. It obtains and processes information from the system user interface to either create or access the database entries for each of the four databases for each particular system user as the user logs onto the system. The processor also creates unique user IDs, network IDs, and PIDs for each system user using a hash algorithm. The processor also facilitates the payments desired by the system user by accessing each database for each particular payment request or action being processed. The processor also sends notifications to the user if a payment transfer is not successful and to the user and target if the transaction is successfully completed.

Using the system and method of the present invention, a system user logs onto the system from the communication device at which time the user is authenticated. The processor then establishes if the user is a new or existing system user. If the user is new to the system of the present invention, the user is prompted to create a profile, which the processor causes to be stored within the profile database. In a preferred embodiment of the present invention, the profile contains basic information about the user such as, but not limited to, name, address, telephone number, and email address. It could also include Federal Tax ID, business type, state and federal vendor numbers, Dunn and Bradstreet reference number, etc. The profile information also may include all networks from which the user can access the system of the present invention and associated information and history from each of the registered networks. Once the profile is created, the processor creates and stores one or more network IDs for each user wherein each network ID corresponds to a specific external network to which the user belongs and from which the user can access the system of the present invention. By way of example and not limitation, if a user belongs to both Facebook and Gmail, a unique network ID will be generated for each of these networks and stored by the processor in the user network database as being associated with that particular system user. Each network ID contains authentication information such as the user's ID and password for each of the user's access networks.

In addition, at the user's option, the profile information may also include payment information which identifies one or more sources from which the system user can make or receive payments such as, but not limited to, bank account information, credit card account information, PayPal account information, gift card information, echeck/ACH information, mobile wallet information or any other type of electronic financial account information or source, which is then stored by the processor in the payment sources database and associated with that particular user. In addition, in a preferred method of the present invention, the user also may prioritize the payment sources into which payments can be received or from which payments can be made.

If the user is not new to the system, each time that the user logs into the system from a network not previously associated with that particular user, the processor generates a new network ID for that user which is stored in the network ID database as being associated with that system user. Each time thereafter that the user logs into the system from that network, the network ID will be accessed by the processor so that the user immediately will be authenticated.

Each time a system user wants to establish a new relationship with another person or entity (hereinafter “target”) for future payments or make a payment to or receive a payment from a new target, the processor requires the user to input certain identifying information about the target to create a target profile which may include, but not limited to, information about the relationship of the parties and the payment transaction being initiated, including but not limited to invoice details, payment details, credit information, transaction history, terms of payment and discounts offered. Over time the payment relationship information is adjusted or modified as transactions continue to occur between the parties and further information is contributed to the system by either the user or the target regarding that payment relationship. By way of example and not limitation, a user may use the system to send an electronic invoice or payables notification to a target wherein the user will initiate the communication by entering information about the target, details about the payment desired and other relevant information related to the payment relationship. In response thereto, the system will establish a new unique PID and a new profile for the target, such that the target upon receipt of the notification/invoice is enabled to become a user of the system and/or add further relevant information to the new unique PID. By way of another example and not limitation, the user can select from a list of user or network contacts those parties to whom or from whom payments will be made. The processor then creates a unique PID to identify that particular user-target relationship and stores the unique PID in the PID database. The PID that is created by the processor contains all relevant profile and network information from all of the databases pertaining to that particular user-target relationship so that any future payments between the user and target regardless of which one is paying the other, will be facilitated.

In a preferred method of the present invention if the user or target has chosen to add at least one payment source for transactions with the target, then a PID is created using a hash algorithm or the like which combines the user profile with the target profile and their payment source profiles. In a preferred method of the present invention if the user chooses not to add the payment source information relating to the target, then a PID is created which combines just the user profile with the target profile, and other available relationship details, but does not include the payment source.

In addition, in an alternative method of the present invention, the PID may also be stored within the user's hardware access devices' database or on both. The PID is stored so that future payments may be made securely between the same two parties (regardless of who is paying whom) without either one having to re-input the information relating to that relationship.

In a preferred method of the present invention, after the user logs on and is authenticated, either a list of registered targets and/or PIDs will be generated on the user's communication device by the system from which the user makes a selection. In an alternative method of the present invention, a static device such as, but not limited to, smart cards, FOB, or gift cards containing their own unique PID, can be used instead of the user selecting a PID/target from the user's list of PIDs/targets. Once the PID/target is either selected or entered into the system through a static device, the processor extracts the target information from the PID using the same hash algorithm or the like by which the PID was originally created. After extracting the target information, the processor either extracts the payment sources available for payment from the PID using the same hash algorithm or if no payment sources are contained within the PID, the processor searches the origin of payment database to determine what associated payment information is available for that user so that payment may be made. If there are several payments sources associated with the user and the user has prioritized the sources, the present invention tries to process a payment using the first payment source and continues trying each subsequent payment source, if any, until it can successfully transfer the funds and make a payment. If no successful transfer can be made, notification is sent to the user. If a successful transfer has been achieved, notification is sent to the user and the target.

### BRIEF DESCRIPTION OF THE DRAWINGS

In order to facilitate an understanding of the present invention, reference is now made to the appended drawings in which like numerals refer to like parts. These drawings should not be construed as limiting the present invention, but are intended to be examples thereof:

FIG. 1 is a flow chart depicting the cross-network system and method for electronic payment processing using a universal ID in accordance with the present invention.

FIG. 2 is a flow chart of the PID creation system and method of the cross-network system and method for electronic payment processing using a universal ID in accordance with the present invention.

FIG. 3 is a flow chart of the payment processing system and method of the cross-network system and method for electronic payment processing using a universal ID in accordance with the present invention.

FIG. 4 is a block diagram depicting the databases used in the cross-network system and method for electronic payment processing using a universal ID in accordance with the present invention.

### DETAILED DESCRIPTION OF THE DRAWINGS

The present invention is a cross-network system and method for electronic payment processing using a universal ID (called “PID”) through which a user can securely and conveniently send payments to or receive payments from anyone who has access to the internet. Using the system and method of the present invention, a user can authorize the sending or the receipt of an electronic invoice or a payment to another person or entity regardless of the user's point or type of entry.

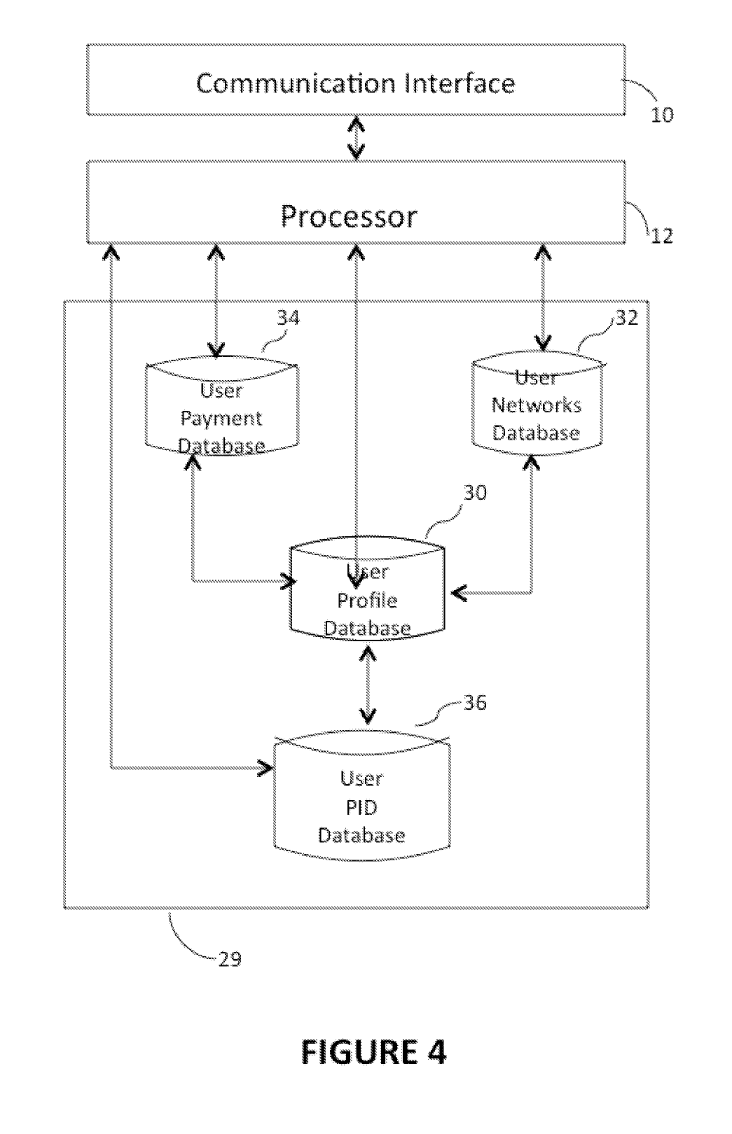

Referring first to FIG. 4, a block diagram of the system of the present invention is shown. The system comprises a communication interface 10, one or more processors 12 and one or more databases 29.

Referring first to FIG. 4, a block diagram of the preferred embodiment of the present invention is shown. A communication interface 10 is electronically connected to a processor 12 which is connected to a database 29. In a preferred embodiment, the database comprises a user profile database 30, a user network database 32, a user payment database 34 and a user PIDs database 36. As shown in FIG. 4, databases 32, 34 and 36 exchange information with the user profile database 30.

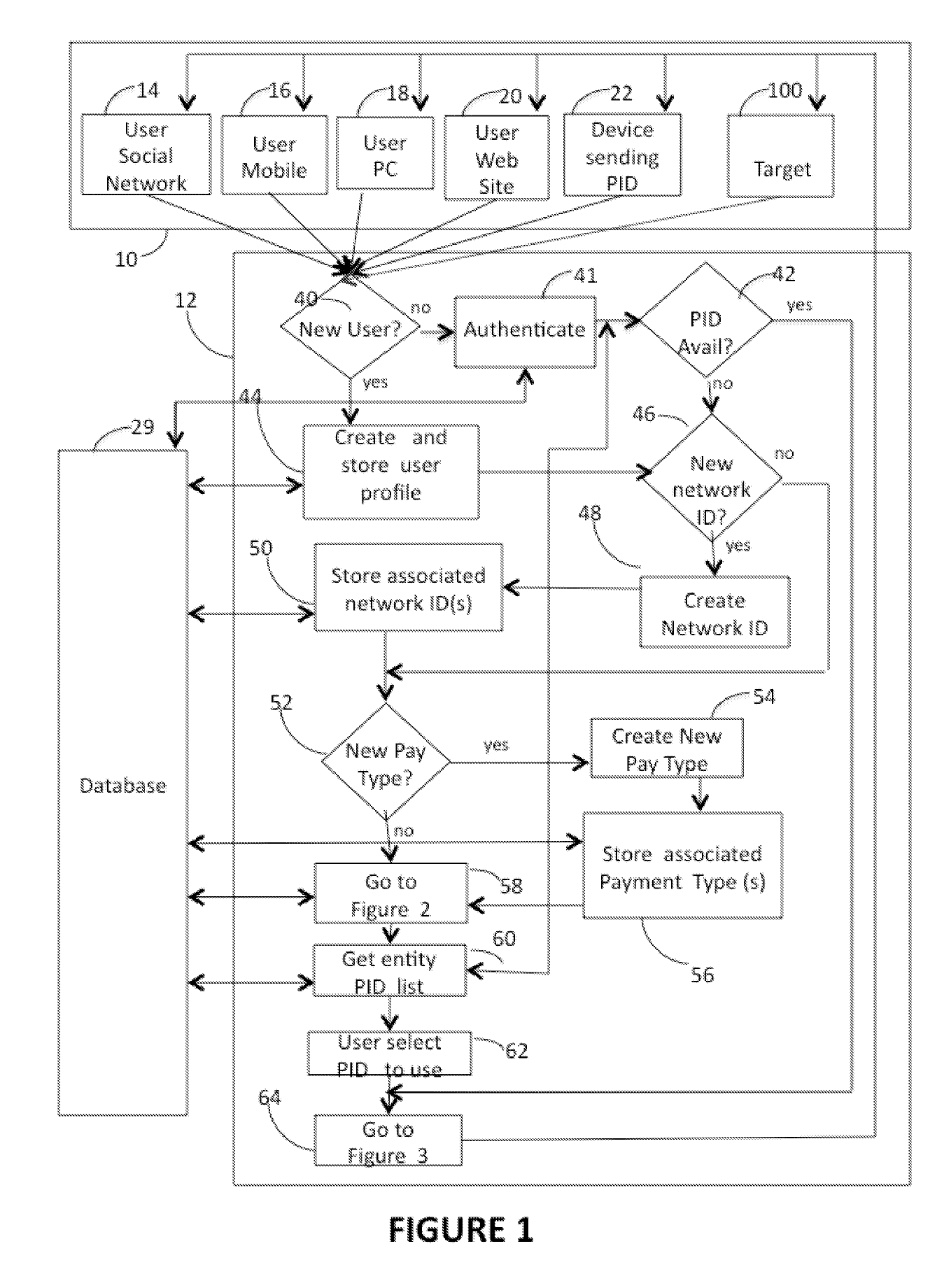

Communication interface 10 can be any hardware device having a platform capable of running applications and capable of receiving and sending information electronically. By way of example and not limitation, as shown in FIG. 1, such devices include mobile phones, mobile wallets or other personal mobile devices 16 having an integrated native platform such as, but not limited to, an Android or an IOS application; a personal computer 18 having a Windows, MAC or other native platform; a user's personal website 20; an Ipad (not shown); a Kindle (not shown), (not shown) or any other suitable personal electronic devices. The communication interface 10 may also be any private or public network 14 that requires that each user of that network sign in with a unique user ID and password which personally identify the user. By way of example, and not limitation, such networks include, but are not limited to, Facebook, LinkedIn, Twitter, My Space, Gmail, Yahoo Mail, Ariba, Salesforce.com, Alibaba, and the like. In an alternative embodiment of the present invention, the communication interface 10 may be a static device such as, but not limited to, smart cards, FOB, or gift cards containing their own unique PID. Thus, in the system of the present invention, the communication interface 10 provides the user with access to the processor 12 of the system.

The processor 12 of the present invention is connected both to the communication interface 10 and database 29. The processor 12 obtains and processes information from the communication interface 10 to authenticate or identify the user and either create or access database entries for each user as the user enters the system. The processor 12 also can create unique user IDs, network IDs, and PIDs for each user using a hash algorithm. In addition, the processor 12 facilitates payments made or invoices sent by the user to a target 100 by accessing information stored within the database 29 for each payment being processed.

The system database 29 resides either in one or more dedicated servers and/or in the system processor 12. Specifically, as shown in FIG. 4 which is a preferred embodiment of the present invention, the database 29 comprises four databases each of which are electronically connected to and accessible to the processor 12. There is a user profile database 30 which stores profile information for each user that has accessed the system. In a preferred embodiment and method of the present invention, the user profile database 30 may contain, but is not limited to, the user's name, address, telephone number, cell phone number, email, internet address, ACH information, banking information, checking account information, Dunn and Bradstreet information, Federal Tax ID, and any other information required by the system, or any combination thereof. The database 29 also includes a user network database 32, which stores network IDs containing the user's credentials for each external network to which the user belongs and on which the user has accessed the system so that each subsequent time that the user accesses the system from one of those same external networks, the system will recognize and authenticate the user. Each network ID created by the processor 12 contains authentication information such as the user's ID and password for each of each user's access networks.

By way of example and not limitation, if a user belongs to both Facebook and LinkedIn, a unique network ID will be generated for each of these networks and stored by the processor in the user network database as being associated with that particular system user. Each subsequent time that the user logs in from that same external network, the system will be able to recognize and authenticate the user.

At the user's option, the profile information may also include payment information which identifies one or more sources from which the system user can make or receive payments such as, but not limited to, MasterCard, Visa Card, American Express Card, bank account information, credit card account information, PayPal account information, gift card information, echeck/ACH information or any other type of electronic financial account information or source. This payment information is stored by the processor 12 in the user payment database 34 as sub-tokens. Each token that is generated by a payment processor represents each different type of electronic payment sources belonging to each system user. In addition, in a preferred method of the present invention, the user also may prioritize the payment sources from which payments can be made or in which payments can be received.

The database 29 also comprises a user PID database which stores a PID/token representing all relevant profile and network information from all of the databases related to a particular user-target/payor-payee relationship. In subsequent transactions between the parties, the same PID can be used to facilitate the transaction.

Each time a system user wants to establish a new relationship with another person or entity (“target”) for future payments or make a payment to or receive a payment from a new target, the processor 10 requires the user to input certain identifying information about the target to create a target profile which may include, but not limited to, information about the relationship of the parties, credit information, transaction history, terms of payment, discounts offered or any other related information. Over time the payment relationship information is adjusted or modified as transactions continue to occur between the parties.

In a preferred embodiment, the system provides a user the choice of selecting some or all of the user's network contacts as those parties to whom or from whom payments may be made. The processor then creates a unique PID to identify that particular user-target relationship and stores it in the PID database 36 for future use.

In another embodiment of the present invention, the information related to each system user and/or the user's PIDs are stored locally on the user's access device(s). In a further embodiment of the present invention, the PIDs are stored in both the system database and the user's access device(s). The PIDs are stored so that future payments may be made securely between the same two parties (regardless of who is paying whom) without either one having to re-input the information relating to that relationship.

Referring to FIG. 1, using the method of the present invention, a user makes contact with the system of the present invention through the communication interface 10. The processor 12 determines in step 40 whether the user is a new user or a registered user, i.e., one who has previously utilized the system. If the user is new, then the processor 12 requests that the user enter certain user profile information as shown in step 42 which is then stored by the processor 12 in the user profile database 30.

In addition, the first time a user enters the system directly through the system's website, a unique user ID and a password will be created for that user and stored by the processor 12 in the user profile database 30. However, if the user enters the system from another network 14, rather than logging directly onto the system's website, the processor 12 creates a network ID which represents the user's network and the user's username and password on that network. Each network ID is stored within the system's user network database 32. Thus, each subsequent time that a user enters the system of the present invention through that same other network, the processor 10 will match the network ID stored within the network database 32 with the credentials sent by the other network, to authenticate 41 the user. Thus, the user will not have to provide credentials to the system so long as the user logs onto the system from the same other network. Additionally, the PID may be made accessible to individual third-party networks for use together with any in-network tools that may exist in each case such as, by way of example, and not limitation, CRM, ERP, and accounting systems and tools and the like.

If a previously registered user logs onto the system from a new other network 46, another network ID will be created by the processor 12 and associated with that user and stored within the user networks database 32. This process is repeated each and every time the user logs in from a new network 46 or new device 10 that the user has not previously used. The next time the user logs into the system from any registered network (i.e. one for which a network ID has already been created and associated with that user), the user will not have to provide any credentials, as the processor 12 will recognize the user by matching the ID sent by the other network with the network IDs in the system's databank 32, thereby identifying and authenticating the user as shown in step 41.

If the user is either new or is a registered user wishing to add or change the types of payments that can be made by the system, the user enters relevant payment source information such as, but not limited to, bank account and bank routing numbers, credit card account information, echeck numbers, etc., which the system sends to a payment processor which creates a sub-token identifying each type of payment that the user can make. The payment sub-tokens are then stored in the user payment database 34 and become a sub-token within the system of PIDs.

Each time that a user initiates a payment request via an electronic invoice or payables notification, or initiates the making of a payment to a target, the processor 12 creates a token, which in a preferred embodiment is known as a PID. The PIDs are stored in the user PID database 36 shown in FIG. 4, which stores each PID associated with each user. The PID is created by the processor 12 using a hash algorithm and represents all relevant information about the relationship between the user and the target, i.e. the person or entity to whom the user wishes to send a payment or an invoice, so that any future transactions between the parties will be facilitated in any context, including, but not limited to, a device, a single or dual third-party network, or by the system itself. Thus, the next time there is a transaction between the same two parties regardless of which party initiated the transaction or in which context/network which either party is using, no additional information will need to be entered except for the amount, different payment source, or both, if this information has not already been fixed.

Once a user is authenticated, the processor 12 presents the user with a list of targets (i.e. payees) with whom the user had a previous transaction such that there is an associated PID stored within the user PID database 36. By selecting a previous target, the processor 12 will retrieve the PID from the PID database 36 and immediately transfer payment according to the prior transaction as shown in steps 42 and 64.

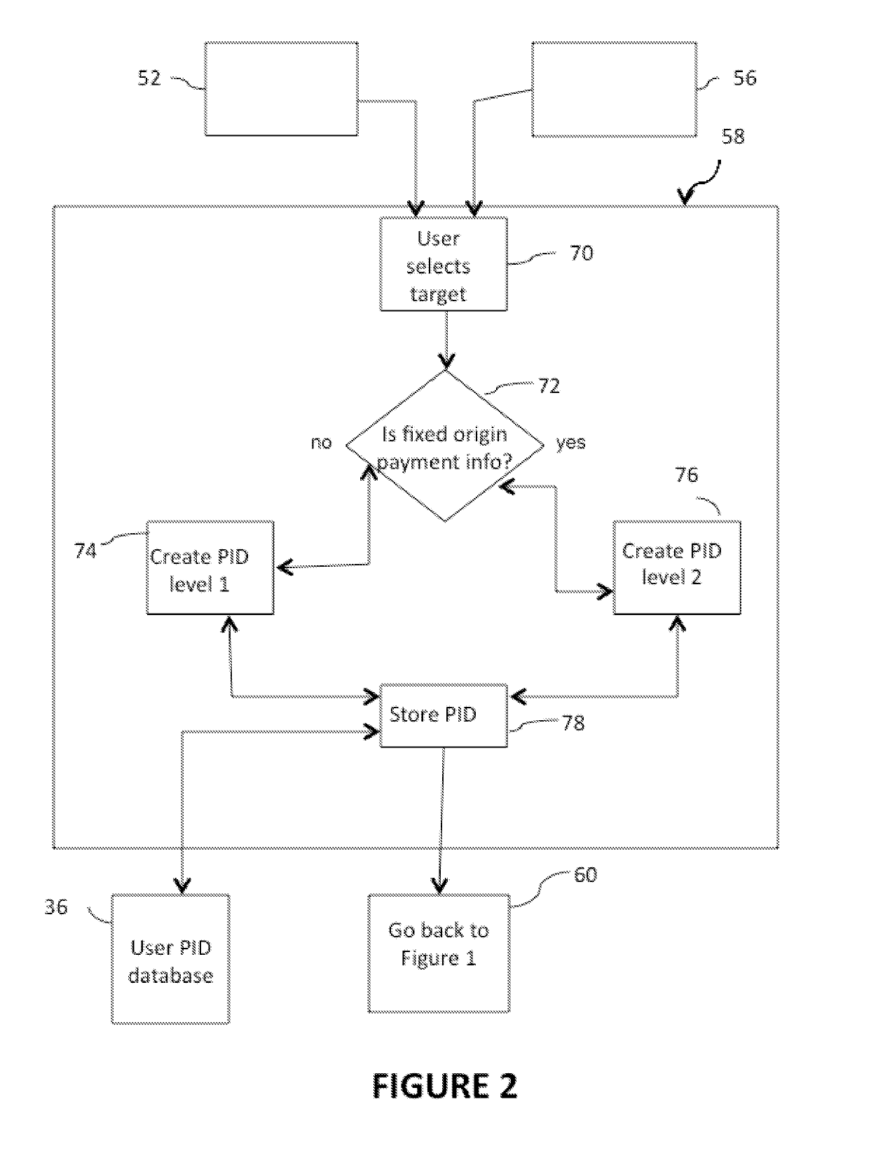

If a PID is not selected or available, the processor 12 determines whether the user has accessed the system using a previously registered network or whether the network is new. If the user is signing on from a new network 46, the processor 12 creates a new network ID 48 which is stored in the user network database 32 shown in FIG. 4 and associated with the user. If the user is signing on from a previously registered network, the processor 12 then asks if the user intends to use a previously registered payment source 52. If the payment source 52 is new, the processor 12 obtains and sends the relevant information to a payment processor and a new token is created regarding that new payment source 54 which is then stored 56 in the user payment database 34 as shown in FIG. 4. If there is no new payment source 52, the processor 12 goes through the steps shown in FIG. 2.

Referring next to FIG. 2, the process for generating a PID is shown. After being authenticated by the system and entering any new information regarding the network 46 from which the user entered the system and/or entering a new payment source 52, if any, the user selects a target 100 to whom he wishes to submit payment or an invoice as represented in step 70. The target 100 can be another user of the system or can be someone who has not been previously registered in the system. Upon the user entering information regarding the target 100, the user is requested to enter the source of payment the user wishes to be associated with that transaction as shown in step 72. If the user does not want a specific source of payment to be associated with the target, then a level 1 PID is created as shown in step 74 using a first hash algorithm. If the user does want a specific source of payment to be associated with the target, then a level 2 PID is created as shown in step 76 using a second hash algorithm. Upon creation of either a level 1 or a level 2 PID, the PID is stored as shown in step 78 within the user PID database 36 for use in all transactions between the user and that specific target.

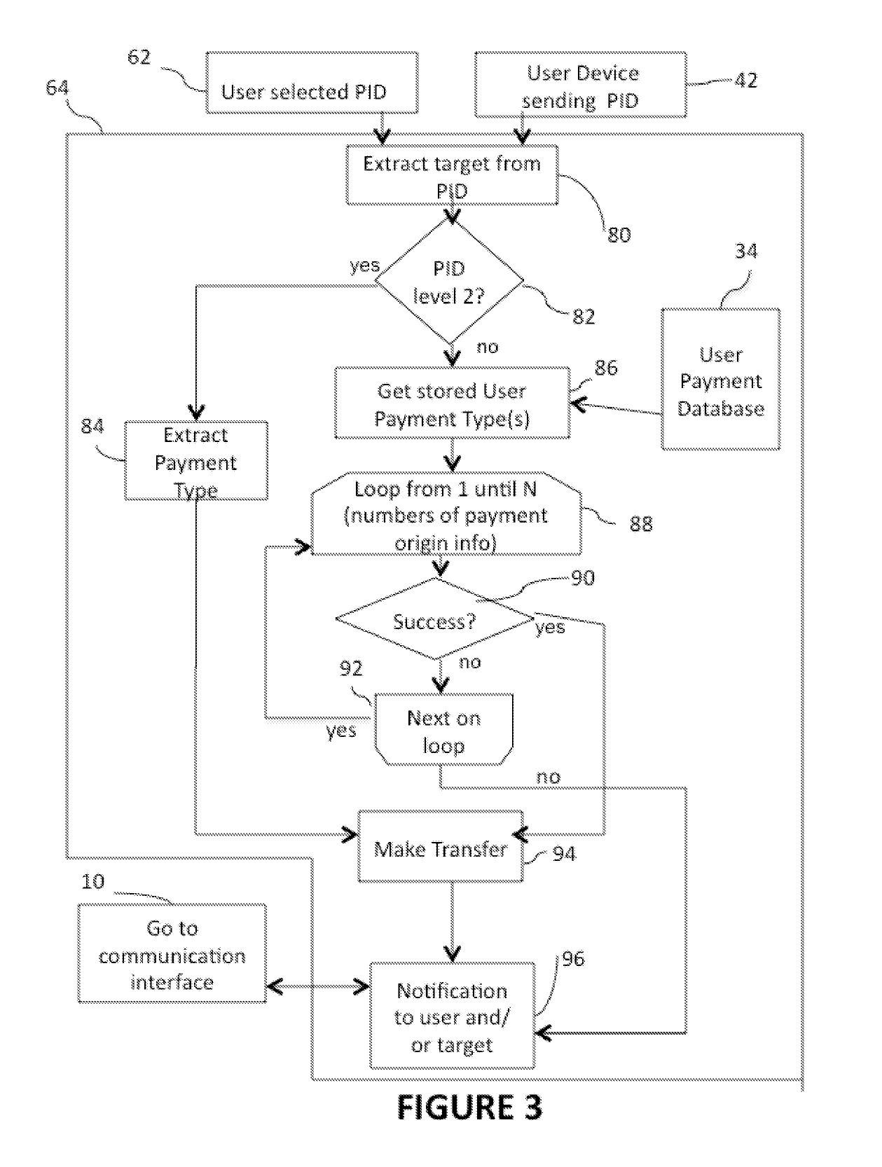

After one or more PIDs have been created and associated with the user, the processor 12 presents the user with a list of targets who have PIDs associated with that user as shown in step 60. The user then selects the registered target as shown in step 78with whom the user has created a PID as shown in step 62 and then the processor goes through the steps shown in FIG. 3.

Referring next to FIG. 3, once the user has selected the PID in step 64 or upon the processor 12 receiving the PID from a device as shown in step 42, the processor extracts the target information from the registered PID as shown in step 80. The processor also goes through the steps set forth in FIG. 3 when the user or the device selects a previously registered PID. If the PID is a level 2 PID, i.e. has the payment information embedded therein, the payment source is extracted as shown in step 84 at which time the processor notifies the payment processor to transfer funds to the target. Alternatively, if the PID is a level one PID, i.e. a PID in which the user has not specified the payment source, the processor 12 will access the user payment database 34 to determine if there are any payment sources on file that are associated with that user as shown in step 86. The processor 12 will continue to try each and every payment sources associated with the user until a successful transfer can be made as shown by the loop represented in steps 88, 90, and 92. If a successful transfer cannot be made or the system has run out of payment sources to try, the processor 12 will send a notification to the user and/or the target of the unsuccessful transaction as shown in step 96 through the communication interface 10. Once a successful transfer is made, the processor 12 will send a notice of same to both the user and the target of the successful transaction as shown in step 96 through the communication interface 10 as shown in FIGS. 1 and 3.

In an alternative method of the present invention, a static device such as, but not limited to, smart cards, FOB, or gift cards containing their own unique PID, can be used instead of the user selecting a PID from the user's list of PIDs. Once the PID is either selected or input into the system from a static device, the processor extracts the target information from the PID using the same hash algorithm by which the PID was originally created. After extracting the target information, the processor either extracts the payment sources available for payment from the PID or if no payment sources are contained within the PID, the processor searches the origin of payment database to determine what associated payment information is available for that user so that payment may be made. If there are several payments sources associated with the user and the user has prioritized the sources, the present invention tries to process a payment using the first payment source and continues trying each subsequent payment source, if any, until it can successfully transfer the funds and make a payment. Once the payment is transferred, notification is sent to the user and the target.

While particular embodiments and techniques of the present invention have been shown and illustrated herein, it will be understood that many changes, substitutions and modifications may be made by those persons skilled in the art. It will be appreciated from the above description of presently preferred embodiments and techniques that other configurations and techniques are possible and within the scope of the present invention. Thus, the present invention is not intended to be limited to the particular embodiments and techniques specifically discussed hereinabove.

What is claimed is:

1. A cross-network system for electronic paying or invoice processing by a system user, comprising:
a communications interface capable of electronic receipt and transmittal of information;
a database for storing information regarding the user, the target, the user's point of entry into the system, the user's or target's payment sources;
a processor which can electronically connect to the communications interface for obtaining, storing and manipulating the information in the database to create a universal ID which contains all relevant profile and network information pertaining to a user-target relationship so that any payments made between the user and the target, regardless of which one is paying the other, will be facilitated.

2. The cross-network system of claim 1 wherein the database comprises four databases:
a user profile database containing all identifying information regarding the user and the target;
a network ID database containing all identifying and credential information for the user in a particular external network from which the user has or intends to have access to the system;
a payment source database containing all financial information regarding the user's payment or payment receipt sources; and
a universal ID database, which contains all relevant profile and network information pertaining to a user-target relationship.

3. The cross network system of claim 1, wherein the communications interface comprises any device that is capable of transferring and receiving information electronically.

4. The cross network system of claim 1 wherein the communications interface comprises any private or public network that requires that each user of that network to possess a unique user ID and password to identify the user.

5. The cross network system of claim 1, wherein the communications interface comprises a static device containing a universal ID from which payments can be made.

6. The cross network system of claim 2, wherein the network ID database also includes identifying information for any hardware devices belonging to each system user from which the user has accessed the system.

7. The cross network system of claim 1, wherein the processor creates unique universal IDs for each system user using a hash algorithm.

8. A cross-network method for electronic paying or invoice processing by a system user, comprising the steps of:
authenticating the user;
presenting the user with a list of registered targets from which the user makes a selection, each user-target relationship having a universal ID associated therewith;
extracting target information from the universal ID associated with the selected user-target relationship;
if a payment is being made, extracting payment source information, if any, from the universal ID associated with the selected user-target relationship; and
notifying the target and the user that a payment has been made or an invoice has been generated.

9. The cross-network method of claim 8, wherein the universal ID does not contain payment source information, further comprising the steps of searching for or requesting that the user provide a payment source from which a payment may be made by the user.

10. The cross-network method of claim 8 wherein the authenticating step further comprises:
requesting the user provide identifying profile information regarding the user and the target to which the user wishes to made an electronic payment or to whom the user wishes to send an electronic invoice;
creating a unique user ID and a password for that user which is stored by the system processor and/or creating a network ID which represents both the network from which the user accessed the system and that network's user personal network credentials or which identifies the specific device from which the user entered the system;
whereby the next time the user logs into the system from any network having an associated network ID, the user will not have to provide any credentials, as the system will recognize the user by matching the ID sent by the other network with the network ID in the system, thereby identifying and authenticating the user.

11. A cross-network method for electronic payment or invoice processing by a new system user, comprising the steps of:
contacting the cross-network system using a communications interface;
requesting the user provide identifying profile information regarding the user and the target to which the user wishes to made an electronic payment or to whom the user wishes to send an electronic invoice;
creating a unique user ID and a password for that user which is stored by the system processor and/or creating a network ID which represents both the network from which the user accessed the system and that network's user personal network credentials or which identifies the specific device from which the user entered the system;
creating a payment source database for each user at the request of the user, which contains all of the payment sources from which or to which the user wishes to make or receive a payment; and
creating and storing a universal ID representing all relevant information about the relationship between the user and the target whereby when the user wishes to send a payment or an invoice so that any future transactions between the parties will be facilitated in any context, including but not limited to a device, a single or dual third-party networks, or the system itself;
whereby a payment or invoice is sent by the user to the target.

12. The cross-network method of claim 11 wherein the step of creating a unique network ID is repeated each and every time the user logs in from a new network or new hardware device that the user has not previously used.

13. The cross-network method of claim 11, wherein each subsequent time the user logs into the system to make a payment or generate an invoice, the user either selects a universal ID representing a user-target relationship or creates a new universal ID from which the target information and payment information embedded therein, if any, is extracted, and the funds or invoice are transferred to the target or if no payment information is embedded in the universal ID, the user enters payment information or the system searches for payment information associated with that user so that the funds can be transferred to the target.

14. The cross-network method of claim 11 wherein if no payment sources are contained within the universal ID, the system searches for any associated payment information for that user so that payment may be made, and if there are several payments sources associated with the user, the system tries to process a payment using the first payment source and continues trying each subsequent payment source any, until it can successfully transfer the funds and make a payment, and if no successful transfer can be made, notification is sent to the user.

15. The cross-network method of claim 11, where the the payment relationship information is adjusted or modified as transactions continue to occur between the parties and further information is contributed to the system by either the user or the target regarding that payment relationship.

16. The cross-network method of claim 11, in which the information regarding the unique user IDs, passwords, network IDs and universal IDs are stored on a database accessible to the system.

17. The cross-network method of claim 11, in which the information regarding the unique user IDs, passwords, network IDs and/or universal IDs are stored within the user's access devices database.
